(19) United States
(12) Patent Application Publication
(10) Pub. No.: US 2026/0027866 A1
(43) Pub. Date: Jan. 29, 2026

(54) DUCT

(71) Applicant: HONDA MOTOR CO., LTD., Tokyo (JP)

(72) Inventors: Yoshiaki Kakuta, Tokyo (JP); Takahiro Koshino, Tokyo (JP)

(21) Appl. No.: 19/270,513

(22) Filed: Jul. 16, 2025

(30) Foreign Application Priority Data
Jul. 29, 2024 (JP) 2024-122260

(51) Int. Cl. B60H 1/00

(52) U.S. Cl. CPC B60H 1/00564

(57) ABSTRACT

The duct has a duct main body into which air is sucked, and a rib that is raised from the bottom of the duct main body with respect to the lid in a non-contact manner and that has a height which varies in the middle of the rib while facing the wall surface of the duct main body. One end of the rib is joined to the wall surface, and the other end of the rib is spaced apart from the wall surface.

### CROSS-REFERENCE TO RELATED APPLICATION

This application claims priority on Japanese Patent Application No. 2024-122260, filed on Jul. 29, 2024, the contents of which are incorporated herein by reference.

### BACKGROUND OF THE INVENTION

### Field of the Invention

The present invention relates to a duct. Here, the duct is a generic name of a tube (mainly air), a duct, a pipe, and the like for transporting gas.

### Description of Related Art

The present invention relates to ducts. Here, the duct is a generic name of a pipe (mainly air), a duct, a pipe, and the like for transporting gas.

### BACKGROUND

In recent years, there has been a growing effort to provide access to sustainable transport systems that also take into account vulnerable groups, such as the elderly, the disabled and children, among the transport participants. To realize this, we are focusing on research and development to further improve the safety and convenience of transportation and the comfort through the development of vehicle habitability.

For example, a duct having a configuration in which an air introducing port is provided in a duct main body and a box-shaped resonator and two tube-shaped resonators are partitioned by ribs in an internal passage of the duct main body is known. According to this duct, air and water are introduced from the air introducing port to the internal passage of the duct main body. The water guided to the internal passage adheres to the inner wall of the duct main body and is separated from the air and is discharged to the outside of the duct main body.

Here, a part of the air guided to the internal passage is guided to the inside of the box-shaped resonator and the two tube-shaped resonators (hereinafter, sometimes referred to as side branches), and the guided air is reflected inside each of the resonators and returned to the internal passage. Thus, the resonance is caused by the box-shaped resonator and the two side branches. Thus, for example, noise in different frequency bands can be reduced (hereinafter, sometimes referred to as “silenced”) (see, for example, Japanese Unexamined Patent Application, First Publication No. 2000-161158).

### SUMMARY OF THE INVENTION

In the conventional duct, in order to reduce noise in different frequency bands, it is necessary to provide a box-shaped resonator and two side branches (i.e., a plurality of resonators) in the internal passage of the duct main body.

Aspects of the present invention provide a duct that can muffle noise in different frequency bands with a single side branch, which in turn contributes to enhanced comfort.

The present invention proposes the following configuration.
(1) A duct includes a duct main body (for example, the duct main body (21) of the embodiment) into which a gas is sucked, and a rib (for example, the rib (22, 102) of the embodiment) that is raised from one of a bottom part (for example, the bottom part (26) of the embodiment) and the lid part (for example, the lid part (27) of the embodiment) of the duct main body with respect to the other one of the bottom part and the lid part in a non-contact manner and that has a height which varies in the middle of the rib while facing the wall surface of the duct main body, and one end of the rib is joined to the wall surface, and the other end of the rib is spaced apart from the wall surface.

With this configuration, the side branch can be provided inside the duct main body by the wall surface of the duct main body and the rib. The side branch reflects sound waves (hereinafter, sometimes referred to as sound) guided from the duct main body and, due to a resonant action which makes the reflected sound interfere with the sound transmitted to the duct main body, generates a so-called side branch effect and reduces the sound of the duct.

Here, the rib is raised in a non-contact manner with respect to the other of the bottom portion and the lid portion of the duct main body. Therefore, the inside of the side branch can be communicated with the inside of the duct main body. That is, the side branch is formed in an open shape in cross section, not in a closed shape. Therefore, the characteristics of the sound reduced by the side branch can be made gentle, and the sound can be reduced in a wide band. Further, the deterioration due to the anti-resonance can be suppressed.

Further, the height of the rib was varied in the middle. Therefore, different branch lengths can be secured in a single side branch. By ensuring different branch lengths, sound in different frequency bands can be reflected from the side branches. Therefore, the reflected sound of the different frequency band can be interfered with the sound transmitted to the duct main body, and the sound of the different frequency band can be reduced.

In this way, the rib was raised in a non-contact manner with respect to the other of the bottom portion and the lid portion of the duct main body, and the height of the rib was varied in the middle. This makes it possible to reduce noise in different frequency bands by a single side branch, for example, and thus to contribute to improvement of comfort.

Hereinafter, the different frequencies reflected from the side branches are sometimes referred to as “silencing frequencies”.

Further, by providing a rib on the other of the bottom portion and the lid portion of the duct main body, the rib can be used as a rigid member. Thus, the rigidity of the duct main body can be increased by the rib. Further, by providing the ribs along the duct main body, it is possible to provide a rectifying effect to the gas sucked into the duct main body.
(2) In the above aspect, the height of the rib may vary in a stepwise manner.

With this configuration, by making the rib heights vary in a stepwise manner, different branch lengths can be secured in a single side branch in stages. This allows different silencing frequencies to be generated in stepwise manner.
(3) In the above aspect, the height of the rib may vary in a slope manner.

With this configuration, by making the rib heights vary in a slope manner, it is possible to generate different mute frequencies at the portions where the rib heights are changed gently.
(4) In the above aspect, at a portion of one end side of the duct to which the rib is joined, a reflective portion (for example, the reflective portion 23 of the embodiment) may be provided in a direction intersecting the rib and protruding in the height direction which is same as the rib.

With this configuration, the distance to the depth portion in the side branch can be adjusted to be short by providing the local reflection portion on the one end side to which the rib is joined. This allows the silencing frequency to be increased by reducing the depth of the side branch. Therefore, the noise in the different frequency bands can be reduced more satisfactorily. The position of the reflecting portion is adjusted in the longitudinal direction of the side branch, so that the sound attenuation frequency can be adjusted as desired.
(5) In the above aspect, the rib in which the height of the rib varies in a stepwise manner may have two or more steps.

With this structure, by providing two or more steps in the ribs in which the height of the rib varies in a stepwise manner, the height of the ribs can be varied in each step. This allows multiple silencing frequencies to be generated in a single side branch in a stepwise manner. For example, when there are a plurality of frequencies intended to be silenced, it is possible to silence the noise in a plurality of frequency bands by increasing the number of stages of the ribs so as to correspond to the number of frequencies intended to be silenced. The number of ribs can be set arbitrarily.
(6) In the above aspect, both ends of the reflection portion may be separated from the wall surface and the rib.

With this configuration, the both ends of the reflection portion are separated from the wall surface and the rib, so that the first passage can be provided between the reflection portion and the wall surface. Further, a second passage may be provided between the reflector and the rib. Therefore, the sound guided to the side branch can be guided to the depth portion of the side branch through the first passage and the second passage. The guided sound can be reflected by the depth section.

In this way, the sound guided to the side branch can be reflected by both the depth portion and the reflection portion. Thus, the distance of the side branch can be made different in the reflecting portion, and different mute frequencies can be generated.

According to the aspect of the present invention, noise in different frequency bands can be muted by a single side branch, and this can contribute to improvement of comfort.

### BRIEF DESCRIPTION OF THE DRAWINGS

FIG. 1 is a perspective view showing a state where a fan is connected to a duct in a first embodiment of the present invention.

FIG. 2 is a sectional view taken along line II-II of FIG. 1.

FIG. 3 is a perspective view showing the inside of the duct in the first embodiment with the lid removed.

FIG. 4 is an enlarged perspective view of part IV of FIG. 3.

FIG. 5 is a cross-sectional view taken along line V-V in FIG. 4.

FIG. 6 is a cross-sectional view taken along line VI-VI of FIG. 4.

FIG. 7 is a graph showing attenuation of noise by the duct of the first embodiment and the duct of Comparative Example 1.

FIG. 8 is a cross-sectional view of a duct in Comparative Example 2.

FIG. 9 is a graph showing attenuation of noise by the duct of the first embodiment and the duct of Comparative Example 2.

FIG. 10 is a perspective view showing the inside of a duct according to a second embodiment of the present invention with a lid removed.

FIG. 11 is a graph showing attenuation of noise by the duct of the second embodiment and the duct of Comparative Example 1.

### DETAILED DESCRIPTION OF THE INVENTION

A duct according to an embodiment of the present invention will be described below with reference to the drawings. In one embodiment of the present invention, air is described as an example of the gas applied to the duct, but a gas other than air can be applied to the duct.

Further, although an intake duct installed upstream of the fan is described as an example of the duct, an exhaust duct installed downstream of the fan can also achieve the same effect and reduce noise. In the case of the exhaust duct, the flow of air and the flow of sound waves are reversed from the intake duct.

### First Embodiment

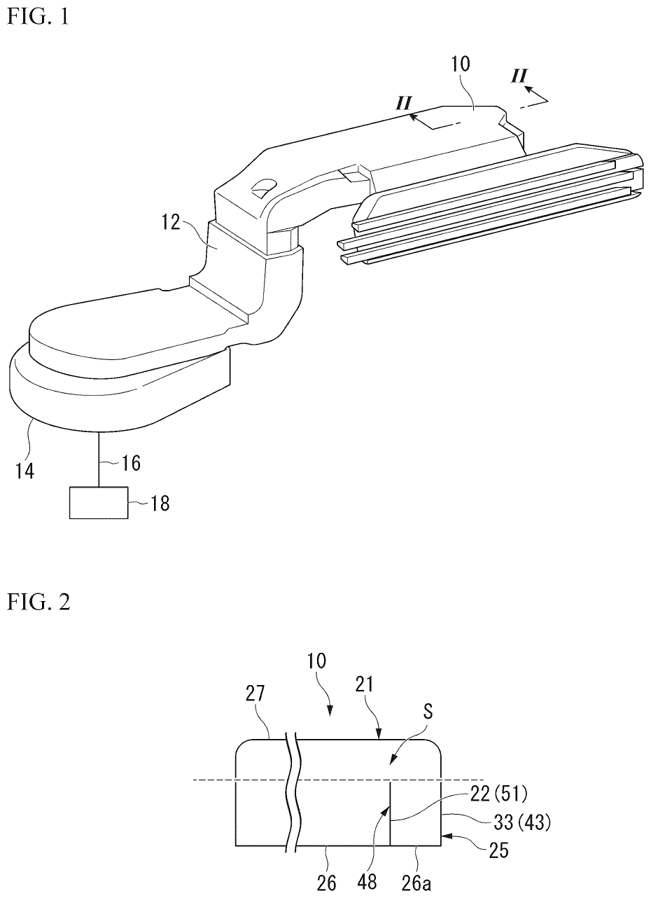

FIG. 1 is a perspective view showing a state where a fan is connected to a duct.

### <Duct>

As shown in FIG. 1, the duct 10 is connected to the fan 14 via the first communication passage 12. The fan 14 is connected to the cooled portion 18 through the second communication 16, for example. The following description will be made by taking the battery 18 as an example of the cooled portion 18, but the cooled portion 18 is not limited to the battery 18.

The duct 10 blows air from the fan 14 by driving the fan 14. The air is blown out from the fan 14, and the air is sucked into the fan 14. Therefore, air is sucked into the duct 10. The sucked air is dewatered inside the duct 10 and is guided to the fan 14 through the first communication passage 12. The air guided to the fan 14 is blown out from the fan 14 and is guided to the battery 18 through the second communication 16. The battery 18 is cooled by the directed air.

### <Duct Main Body>

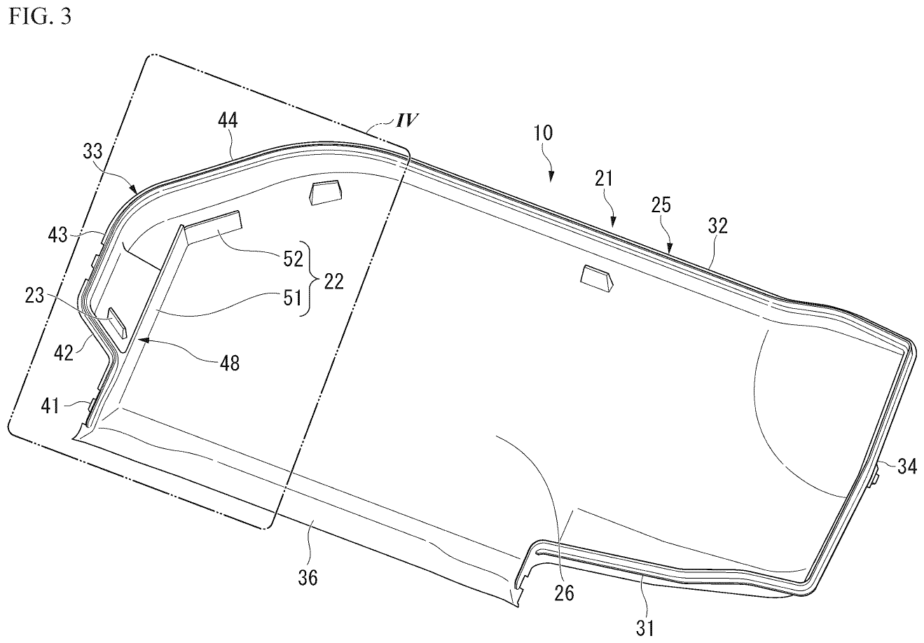

FIG. 2 is a sectional view taken along line II-II in FIG. 1. FIG. 3 is a perspective view showing the inside of the duct with the lid removed.

As shown in FIGS. 2 and 3, the duct 10 has a duct main body 21, a rib 22, and a reflecting portion 23.

The duct main body 21 is formed in a substantially rectangular shape in a plan view. The duct main body 21 has a peripheral wall 25, a bottom portion 26, and a lid portion 27. The peripheral wall 25 has a first long wall 31, a second long wall 32, a first short wall 33, and a second short wall 34. The first long wall 31 and the second long wall 32 are arranged to face each other. The first short wall 33 and the second short wall 34 are arranged to face each other. The peripheral wall 25 is formed in a substantially rectangular frame by the first long wall 31, the second long wall 32, the first short wall 33, and the second short wall 34. A bottom portion 26 is provided at the lower end of the peripheral wall 25. A lid 27 is provided at the upper end of the peripheral wall 25.

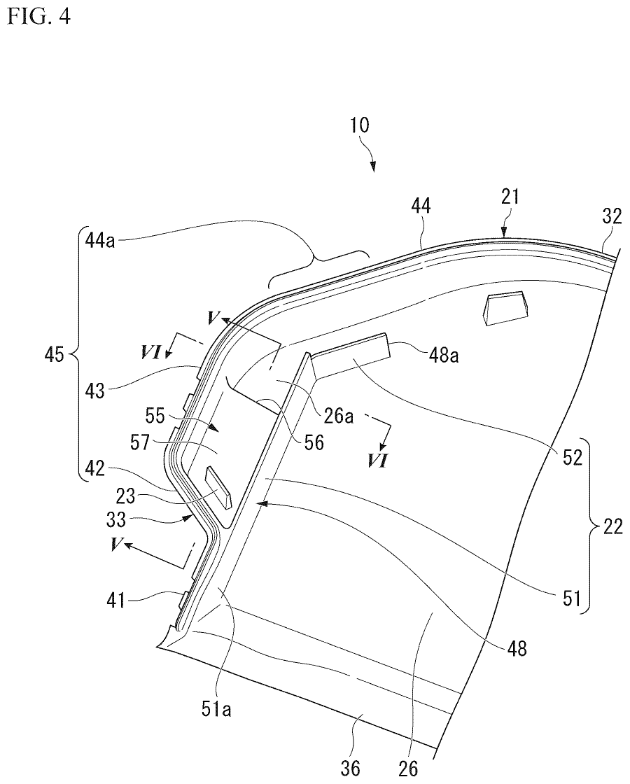

FIG. 4 is an enlarged perspective view of the portion IV of FIG. 3.

As shown in FIGS. 3 and 4, the first long wall 31 is provided with a suction port 36. The suction port 36 sucks air from the outside of the duct main body 21 into the inside of the duct main body 21. The first short wall 33 has, for example, a first wall 41, a second wall 42, a third wall 43, and a fourth wall 44. The first wall 41 is provided along the suction port 36. The second wall 42 is inclined from the first wall 41 toward the outside of the duct main body 21. The third wall 43 is disposed along the second wall 42 to the second short wall 34. The fourth wall 44 is inclined from the third wall 43 to the second long wall 32. The first short wall 33 has a bulge portion 45 formed by the second wall 42, the third wall 43, and a portion 44a of the fourth wall 44. The bulge portion 45 is generally formed in a trapezoidal shape and bulge portions outward from the duct main body 21.

### <Rib>

As shown in FIGS. 2 and 4, the rib 22 is raised from the bottom portion (one side) 26 of the duct main body 21 to the lid portion (other side) 27 in a non-contact manner. Therefore, a space S is formed between the rib 22 and the lid portion 27. The rib 22 is provided in the first short wall 33 so as to face each of the wall surfaces of the second wall 42, the third wall 43, and the part 44a of the fourth wall 44 (i.e., the wall surface of the bulge portion 45) with a gap therebetween.

By providing the rib 22 on the bottom portion 26 of the duct main body 21, the side branch 48 is formed in a U-shaped cross section by the rib 22, the bulge portion 45, and the part 26a of the bottom portion 26. The inside of the side branch 48 is communicated with the inside of the duct main body 21 through a space S. Hereinafter, the bottom portion 26a is sometimes referred to as a “branch bottom portion 26a”.

In the first embodiment, an example in which the rib 22 is raised from the bottom portion 26 with respect to the lid portion 27 in a non-contact manner will be described, but the present invention is not limited thereto. As another example, the rib 22 may be raised from the lid 27 with respect to the bottom 26 in a non-contact manner.

The rib 22 has a first rib 51 and a second rib 52. The base end (one end of the rib 22) 51a of the first rib 51 is joined to the wall surface of the first wall 41 at the first short wall 33. Accordingly, the base end of the side branch 48 is closed by the wall surface of the second wall 42. Hereinafter, the wall surface of the second wall 42 is sometimes referred to as the “depth portion 42” of the side branch 48.

The first rib 51 extends linearly along the third wall 43 toward a portion 44a of the fourth wall 44. The first rib 51 is provided so as to face the wall surfaces of the second wall 42 and the third wall 43 in the first short wall 33. The second wall 42 and the third wall 43 form a part of the bulge portion 45. The first ribs 51 are spaced apart from the wall surfaces of the second wall 42 and the third wall 43. A second rib 52 is integrally provided at the tip of the first rib 51.

The second rib 52 extends from the tip end of the first rib 51 along the wall surface of the portion 44a of the fourth wall 44. The second rib 52 is provided in a inclined manner with respect to the first rib 51. That is, the rib 22 is formed in a state where the first rib 51 and the second rib 52 are bent. The tip end of the second rib 52 (the other end of the rib 22) is spaced apart from the wall surface of the portion 44a of the fourth wall 44. Therefore, the opening 48a is provided at the tip of the side branch 48. Thus, the inside of the side branch 48 is communicated with the inside of the duct main body 21 through the opening 48a.

The second rib 52 is formed so as to be lower one step than the first rib 51 in height from the bottom portion 26. That is, the rib 22 is formed so that the height thereof is different in two steps at a position in the middle of the boundary between the first rib 51 and the second rib 52.

In the first embodiment, the case of the stepped rib having two different heights is described as an example, but the present invention is not limited to this. As another example, the height of the stepped ribs 22 may be varied by two or more steps.

In the first embodiment, the height of the second rib 52 is suppressed to be lower than the height of the first rib 51 by one step, but the present invention is not limited to this. As another example, the height of the first rib 51 may be reduced by one step with respect to the height of the second rib 52.

In the first embodiment, the rib 22 is formed in a bent state by the first rib 51 and the second rib 52, but the present invention is not limited to this. As another example, the rib 22 may be formed in a straight line.

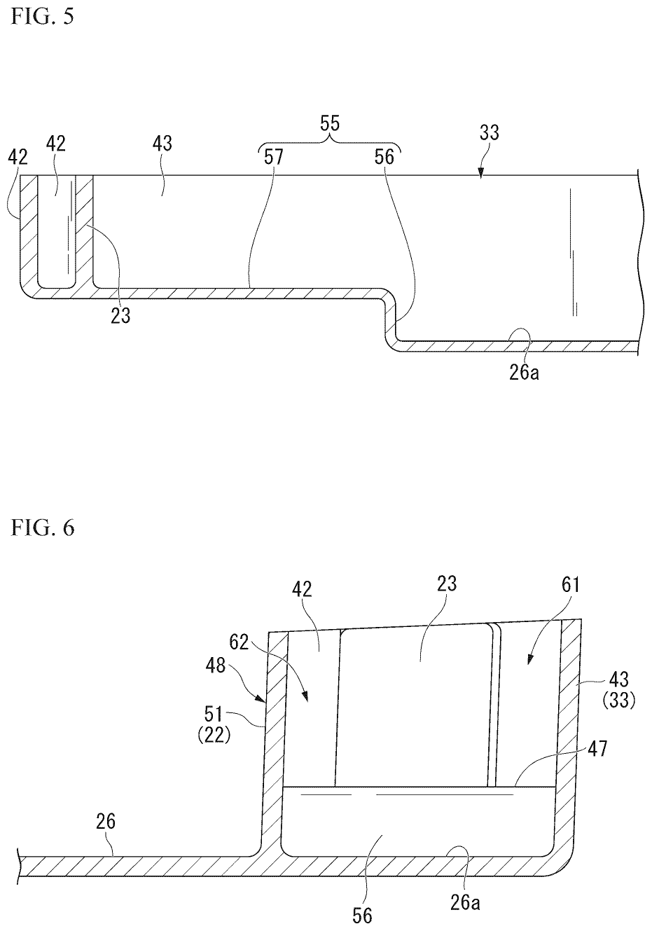

FIG. 5 is a sectional view taken along the line V-V in FIG. 4.

As shown in FIGS. 4 and 5, the branch bottom portion 26a has a raised portion 55. The raised portion 55 has a stepped surface 56 and a raised surface 57. The stepped surface 56 rises from the branch bottom portion 26a to the inside of the side branch 48 at between the first rib 51 and the third wall 43. The raised surface 57 extends from the stepped surface 56 to the second wall 42.

### <Reflecting Portion>

FIG. 6 is a sectional view taken along line VI-VI in FIG. 4.

As shown in FIGS. 4 to 6, the reflecting portion 23 is provided at a position on the base end side of the first rib 51 (i.e., the depth portion 42 side, the one end side of the rib 22) in the raised surface 57. The reflecting portion 23 is provided along the wall surface of the second wall 42 in a direction intersecting (intersecting) the first rib 51, for example. The reflection portion 23 protrudes from the raised surface 57 in the same height direction as the first rib 51. Both ends of the reflecting portion 23 are separated from the wall surface of the third wall 43 and the first rib 51. In the first embodiment, the reflection portion 23 is protruded from the raised surface 57, but the present invention is not limited to this. As another example, for example, when the rib 22 is raised from the lid portion 27 (see FIG. 2) in a non-contact manner with respect to the bottom portion 26, the reflective portion 23 may be protruded from the lid portion 27.

As described above, according to the duct 10 according to the first embodiment, as shown in FIG. 4, the side branch 48 can be provided inside the duct main body 21 by the wall surface of the bulge portion 45 and the rib 22. The side branch 48 reflects the sound wave (hereinafter, sometimes referred to as sound) guided from the duct main body 21 through the opening 48a on the wall surface of the depth portion 42 with a phase shift. The reflected sound is transmitted to the duct main body from the opening 48a of the side branch 48. The sound reflected by the side branch 48 generates a so-called side branch effect by a resonance effect that interferes with the sound transmitted inside the duct main body 21, and cancel each other out. Therefore, the noise of the duct 10 can be reduced. Here, for example, the length of the side branch 48 is preferably set to approximately ¼ wavelength.

As shown in FIGS. 2 and 4, the rib 22 is raised from the bottom portion 26 with respect to the lid portion 27 of the duct main body 21 so as not to be in contact with the lid portion 27. Therefore, the inside of the side branch 48 is communicated with the inside of the duct main body 21 through the space S. That is, the side branch 48 is formed in a shape in which the cross section is not closed but is opened with the space S. Therefore, the characteristics of the sound to be reduced by the side branch 48 are made gentle, and the sound can be reduced in a wide band. Further, by communicating the inside of the side branch 48 with the inside of the duct main body 21 through the space S, deterioration due to anti-resonance can be suppressed.

Further, the height of the rib 22 is made different between the first rib 51 and the second rib 52 in the middle. Therefore, different branch lengths can be secured in the single side branch 48. By ensuring different branch lengths, sound in different frequency bands can be reflected from the side branch 48. Therefore, the reflected sound of the different frequency band can be interfered with the sound transmitted to the duct main body 21, and the sound of the different frequency band can be reduced.

In this way, the rib 22 is raised in a non-contact manner with respect to the lid portion 27 of the duct main body 21, and the height of the rib 22 is varied in the middle. Thus, for example, noise in different frequency bands can be muted by the single side branch 48, and this contributes to improvement of comfort.

Hereinafter, the different frequencies reflected from the side branch 48 are sometimes referred to as “mute frequencies”.

Further, by providing the rib 22 at the bottom portion 26 of the duct main body 21, the rib 22 can also be used as a rigid member. Thus, the rigidity of the duct main body 21 (particularly, the bottom portion 26) can be increased by the rib 22.

Further, by providing the rib 22 along the bulge portion 45 of the duct main body 21, the duct main body 21 can have a flow regulating effect on the air sucked in from the suction port 36.

The ribs 22 are formed in a stepped shape. Therefore, different branch lengths can be secured by stepwise in a single side branch 48. This allows different silencing frequencies to be generated by stepwise.

Further, as shown in FIGS. 4 to 6, a reflecting portion 23 is provided at a position on the side of the depth portion 42. Therefore, the distance until the depth portion 42 in the side branch 48 can be adjusted to be short. Thus, the depth of the side branch 48 is shortened, thereby increasing the silencing frequency. Therefore, the noise in the different frequency bands can be reduced more satisfactorily. The position of the reflecting portion 23 is adjusted in the longitudinal direction of the side branch 48, so that the sound attenuation frequency can be adjusted as desired.

In addition, the number of steps of the stepped ribs 22 shown in FIG. 4 may be two or more. Accordingly, the height of the rib 22 can be varied in each step. This allows a plurality of mute frequencies to be generated in a single side branch 48 in a stepwise manner. For example, when there are a plurality of frequencies to be silenced, by increasing the number of stages of the ribs 22 corresponding to such number of frequencies, noises can be silenced in a plurality of frequency bands. The number of the ribs 22 can be set arbitrarily.

As shown in FIGS. 4 to 6, the both ends of the reflection portion 23 are separated from the wall surface of the third wall 43 and the first rib 51. Therefore, the first passage 61 can be provided between the reflecting portion 23 and the wall surface of the third wall 43. Further, a second passage 62 can be provided between the reflecting portion 23 and the first rib 51. Thus, the sound guided to the side branch 48 can be guided until the depth portion 42 of the side branch 48 through the first passage 61 and the second passage 62. The guided sound can be reflected by the depth section 42. The sound guided to the side branch 48 can also be reflected by the reflecting section 23.

In this way, the sound guided to the side branch 48 can be reflected by both the depth section 42 and the reflection section 23. Thus, the distance of the side branch can be varied in the reflecting section 23, and different mute frequencies can be generated.

Here, the branch bottom portion 26a is provided with a stepped surface 56 of the raised portion 55. The stepped surface 56 rises from the branch bottom 26a into the side branch 48. Therefore, the sound guided to the side branch 48 can be reflected even by the step surface 56. Thus, the distance of the side branch can be varied on the step surface 56, and different mute frequencies can be generated more appropriately.

Next, the amount of attenuation of noise by the duct 10 of the first embodiment will be described with reference to FIGS. 4 and 7 to 9.

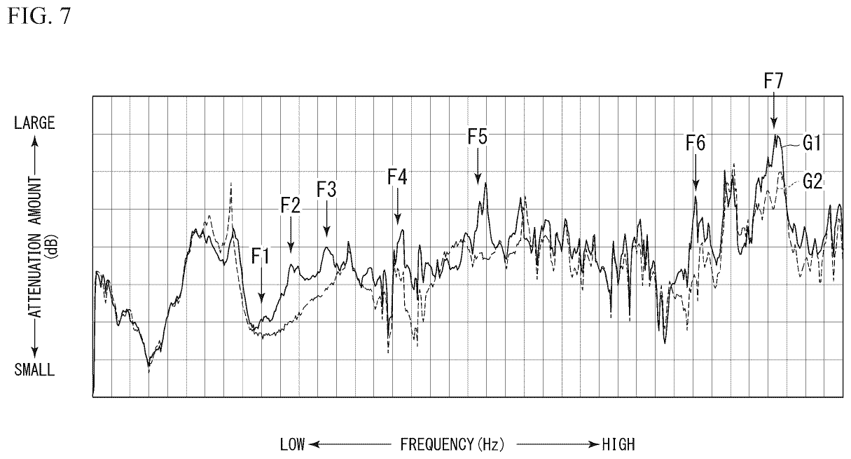

First, an example of comparing the attenuation amount of noise by the duct 10 of the first embodiment with that of the comparative example 1 will be described with reference to FIGS. 4 and 7.

FIG. 7 is a graph showing the attenuation of noise by the duct of the first embodiment and the duct of the first comparative example.

In FIG. 7, the vertical axis represents the attenuation amount, and the horizontal axis represents the frequency. The attenuation amount of the duct 10 according to the first embodiment is indicated by a solid line graph G1. The attenuation of the duct according to Comparative Example 1 is shown by a broken line graph G2. The duct of the comparative example is the duct 10 of the first embodiment from which the rib 22 is removed. That is, the duct of Comparative Example 1 does not include the side branch 48 of the first embodiment.

As shown in the graph G1 of FIG. 7, it is understood that the duct 10 of the first embodiment has a larger noise attenuation amount than the duct of the comparative example 1 shown in the graph G2 at seven frequencies of F1 to F7. That is, it was confirmed that the duct 10 of the first embodiment can appropriately reduce noise in seven different frequency bands F1 to F7 with the single side branch 48.

Next, an example of comparing the attenuation amount of noise by the duct 10 of the first embodiment with that of the comparative example 2 will be described with reference to FIGS. 4, 8, and 9.

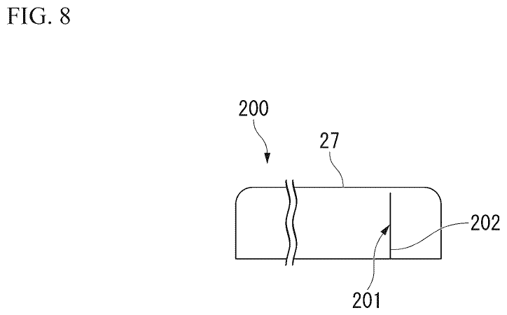

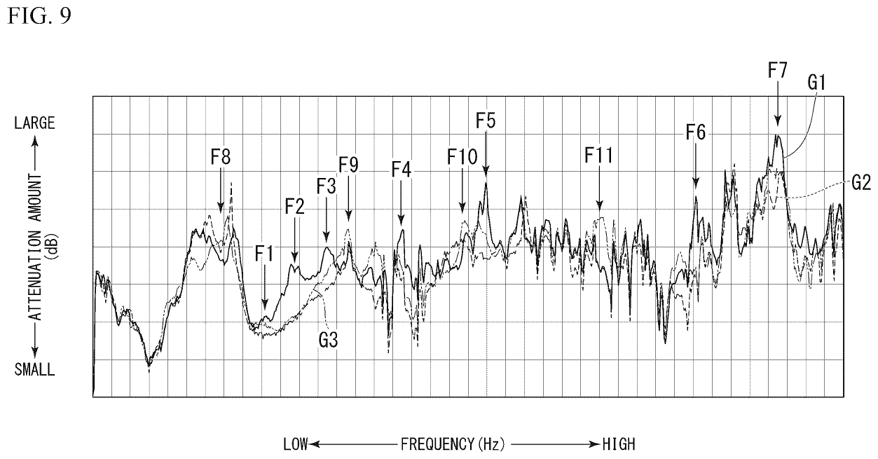

FIG. 8 is a sectional view showing a duct in Comparative Example 2. FIG. 9 is a graph showing the attenuation of noise by the duct of the first embodiment and the duct of the second comparative example.

In FIG. 9, the vertical axis represents the attenuation amount, and the horizontal axis represents the frequency. The attenuation amount of the duct 10 according to the first embodiment is indicated by a solid line in the graph G1. The attenuation of the duct according to Comparative Example 1 is indicated by an imaginary line in the graph G2. The attenuation of the duct 200 according to Comparative Example 2 is indicated by an imaginary line in the graph G3.

As shown in FIG. 8, the duct 200 of Comparative Example 2 is such that the side branch 48 provided in the duct 10 of the first embodiment is replaced with a side branch 201. The side branch 201 is raised until the rib 202 contacts the lid 27. That is, the side branch 201 is sealed in a square-shaped cross section.

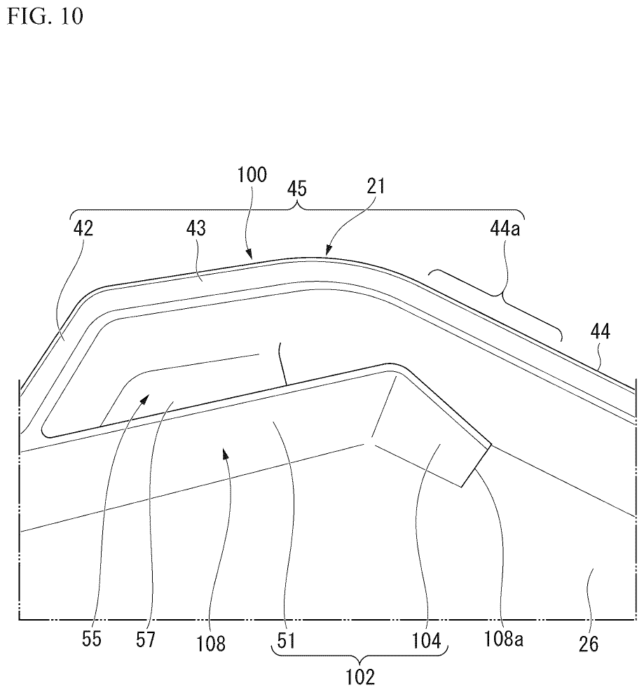

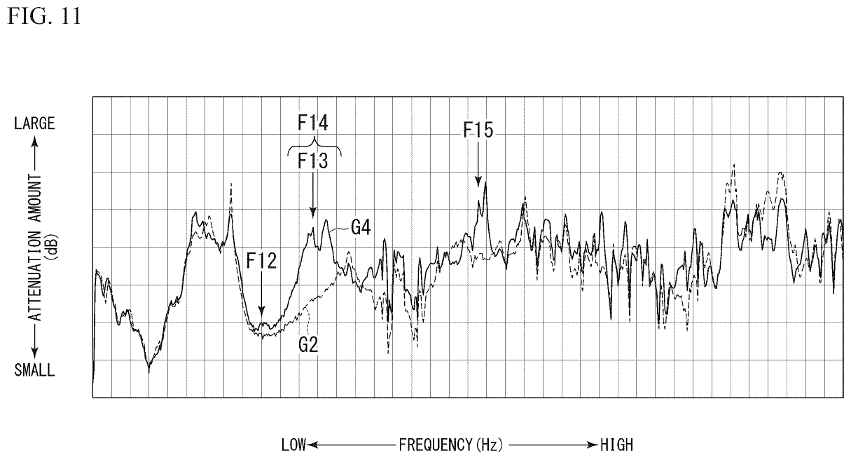

As shown in the graph G3 of FIG. 9, it is understood that the duct 200 of the comparative example 2 has a larger noise attenuation amount than the duct of the comparative example 1 shown in the graph G2 at four frequencies from F8 to F11. In contrast, the duct 10 of the first embodiment has a larger noise attenuation than the duct 200 of the comparative example 2 shown in the graph G3 at seven frequencies of F1 to F7. That is, it was confirmed that the duct 10 of the first embodiment can appropriately reduce noise in seven different frequency bands F1 to F7 with the single side branch 48. Next, a duct of the second embodiment will be described with reference to FIGS. 10 and 11. In the second embodiment, the same or similar members as those of the duct 10 of the first embodiment are denoted by the same reference numerals and a detailed description thereof will be omitted.

### Second Embodiment

FIG. 10 is a perspective view showing the inside of the duct in the second embodiment with the lid removed. As shown in FIG. 10, the duct 100 is formed by replacing the rib 22 of the first embodiment with a rib 102. The other configuration of the duct 100 is the same as that of the duct 10 of the first embodiment. The rib 102 is raised from the bottom portion (one side) 26 of the duct main body 21 with respect to the lid portion (other side) 27 (see FIG. 2) in a non-contact manner, as in the rib 22 of the first embodiment. By providing the rib 102 on the bottom portion 26 of the duct main body 21, the side branch 108 is formed in a U-shaped cross section by the rib 102, the swollen portion 45, and a part 26a of the bottom portion 26 (see FIG. 2).

The rib 102 has a first rib 51 and a second rib 104. The second rib 104 extends from the tip of the first rib 51 along the wall surface of the portion 44a of the fourth wall 44. The second rib 104 is provided in an inclined manner with respect to the first rib 51. That is, the rib 102 is formed in a state where the first rib 51 and the second rib 104 are bent. The tip end (the other end of the rib 102) of the second rib 104 is spaced apart from the wall surface of the portion 44a of the fourth wall 44. Therefore, the opening 108a is provided at the tip of the side branch 108. Thus, the inside of the side branch 108 is communicated with the inside of the duct main body 21 through the opening 108a.

The second rib 104 is formed in a sloped manner (inclined manner) so that the height from the bottom portion 26 gradually decreases from the first rib 51 toward the tip. That is, the ribs 102 are formed so that the heights thereof are varies in a slope manner at a position in the middle of the boundary between the first rib 51 and the second rib 104.

In the second embodiment, the height of the second rib 104 is lowered in a slope manner with respect to the height of the first rib 51, but the present invention is not limited to this. As another example, the height of the first rib 51 may be reduced in a slope manner with respect to the height of the second rib 104.

In the second embodiment, the rib 102 is formed in a bent state by the first rib 51 and the second rib 104, but the present invention is not limited to this. As another example, the rib 102 may be formed in a straight line.

According to the duct 100 of the second embodiment described above, the ribs 102 are made to have different heights in a slope manner. Thus, different mute frequencies can be generated at the portions where the height of the ribs 102 is changed gently. The rib 102 is raised with respect to the lid 27 (see FIG. 2) of the duct main body 21 in a non-contact manner. Thus, for example, noise in different frequency bands can be muted by the single side branch 108, which contributes to improvement of comfort.

Furthermore, the duct 100 of the second embodiment can provide the same operation and effect as the duct 10 of the first embodiment.

Next, an example of comparing the attenuation amount of noise by the duct 10 of the second embodiment with that of the comparative example 1 will be described with reference to FIG. 11.

FIG. 11 is a graph showing the attenuation of noise by the duct 100 of the second embodiment and the duct of the first comparative example.

In FIG. 11, the vertical axis represents the attenuation amount, and the horizontal axis represents the frequency. The attenuation amount of the duct 100 according to the second embodiment is indicated by a solid line graph G4. The attenuation of the duct according to Comparative Example 1 is shown by a broken line graph G2. The duct of the comparative example is the duct 100 of the second embodiment from which the rib 102 is removed. The duct of Comparative Example 1 does not include the side branch 108 of the second embodiment. That is, the duct of Comparative Example 1 has the same configuration as the duct of Comparative Example 1 shown in FIG. 7.

As shown in the graph G4 of FIG. 11, it is understood that the duct 100 of the second embodiment has a larger noise attenuation amount than the duct of the comparative example 1 shown in the graph G2 at four frequencies from F12 to F15. That is, it was confirmed that the duct 100 of the second embodiment can appropriately reduce noise in four different frequency bands from F12 to F15 by providing the single side branch 108.

The technical scope of the present invention is not limited to the above embodiment, and various modifications can be made without departing from the scope of the present invention.

In addition, the components in the above embodiments may be replaced with well-known components, and the above modifications may be combined as appropriate, without departing from the scope of the present invention.

What is claimed is:

1. A duct comprising:
a duct main body into which gas is sucked; and
a rib that is raised from one of a bottom portion and a lid portion of the duct main body with respect to other one of the bottom portion and a lid portion in a non-contact manner and that has a height which varies in a middle of the rib while facing a wall surface of the duct main body,
wherein one end of the rib is joined to the wall surface, and other end of the rib is spaced apart from the wall surface.

2. The duct according to claim 1,
wherein the height of the rib varies in a stepwise manner.

3. The duct according to claim 1,
wherein the height of the rib varies in a slope manner.

4. The duct according to claim 1,
wherein, at a portion of one end side of the duct to which the rib is joined, the duct includes a reflection portion that is provided in a direction intersecting the rib and that protrudes in a height direction which is same as the rib.

5. The duct according to claim 2,
wherein the rib in which the height of the rib varies in a stepwise manner has two or more steps.

6. The duct according to claim 4,
wherein both ends of the reflecting portion are separated from the wall surface and the rib.
